(19) United States
(12) Patent Application Publication
(10) Pub. No.: US 2012/0225983 A1
(43) Pub. Date: Sep. 6, 2012

(54) ADHESIVES AND SEALANTS COMPRISING ESTERS BASED ON 2-PROPYLHEPTANOL

(76) Inventors: Jochen Wagner, Ruppertsweiler (DE); Boris Breitscheidel, Limburgerhof (DE); Tobias Austermann, Muenster (DE); Helmut Mack, Traunstein (DE)

(21) Appl. No.: 13/508,166

(22) PCT Filed: Nov. 2, 2010
(86) PCT No.: PCT/EP10/66575

§ 371 Date: May 4, 2012

(30) Foreign Application Priority Data
Nov. 5, 2009 (EP) 09175122.2

(51) Int. Cl. C08K 5/12; C09J 133/08; C09J 175/04

(52) U.S. Cl. 524/296

(57) ABSTRACT

The invention provides an adhesive or sealant comprising (A) at least one compound selected from the group consisting of polyurethanes, polyureas, polyacrylates, aqueous polyacrylates, silicones, polysulphides, silylated polyurethanes, silylated polyureas, silylated polyethers, silylated polysulphides and silyl-terminated acrylates, and (B) at least one ester of an aliphatic or aromatic dicarboxylic or tricarboxylic acid with a C₁₀ alcohol component comprising 2-propylheptanol or comprising a C₁₀ alcohol mixture comprising 2-propylheptanol and at least one of the C₁₀ alcohols 2-propyl-4-methylhexanol, 2-propyl-5-methylhexanol, 2-isopropylheptanol, 2-isopropyl-4-methylhexanol, 2-isopropyl-5-methylhexanol and/or 2-propyl-4,4-dimethylpentanol, the aliphatic or aromatic dicarboxylic or tricarboxylic acid being selected from the group consisting of citric acid, phthalic acid, isophthalic acid, terephthalic acid, and trimellitic acid, the adhesive or sealant containing no isononyl benzoate. A process is disclosed for preparing the adhesive or sealant, and also disclosed is the use thereof for producing material bonds between parts to be joined.

### DESCRIPTION

The present invention relates to adhesives and sealants based on specific binders comprising at least one ester based on 2-propylheptanol, to a process for preparing them, and to their use.

Adhesives and sealants based on polyurethanes, polyureas, polyacrylates, aqueous polyacrylates, silicones, polysulphides, silylated polyurethanes, silylated polyureas, silylated polyethers, silylated polysulphides and silyl-terminated acrylates have a very broad application spectrum and are used, in formulations adapted to the particular end use, in—for example—construction and civil engineering, in the aircraft or automotive industry, and in watercraft construction. A key component of such a formulation is generally plasticizers, which may account for a fraction of more than 40% of the total formulation. Plasticizers, according to DIN 55945, are inert organic solids and liquids with a low vapor pressure. Through their solvency and swelling capacity, they reduce the hardness of the polymer, compatibilize the filler/polymer mixture, and raise the low-temperature elasticity. Plasticizers in adhesives and sealants also serve in particular to increase the expandability of the film that is produced.

WO 2007/093381 relates to one-component, solvent-free contact adhesives based on mixtures of silane-terminated polyoxyalkylenes and silane-terminated polyalkyl acrylates or methacrylates, which can also comprise plasticizer additives. Suitable plasticizers referred to in the description generically are phthalic esters, cyclohexanedicarboxylic esters or polypropylene oxide; the examples use solely diisodecyl phthalate as plasticizer.

WO 2008/027463 relates to self-hardening sealant compositions composed of acrylic polymers, polyurethanes, polyureas and/or silane-modified polymers, which comprise at least one C₄ to C₈ alkyl terephthalate.

Adhesives and sealants are intended to have very good processing properties, in other words to be capable of application without substantial exertion of force. Moreover, after crosslinking, they are to obtain high levels of expansion and to have a low Shore A hardness.

Given that the stated compounds and methods have still not ultimately solved the fundamental problem of optimizing the properties of adhesives and sealants based on polyurethanes, polyureas, polyacrylates, aqueous polyacrylates, silicones, polysulphides, silylated polyurethanes, silylated polyureas, silylated polyethers, silylated polysulphides and silyl-terminated acrylates, the object on which the present invention is based was that of developing other cost-effective formulations based on these polymers. In such formulations, the adhesives and sealants should have a relatively low hardness and also improved flow properties, and at the same time ought to attain relatively high tensile strengths.

The object has been achieved in accordance with the invention by means of adhesives or sealants comprising (A) at least one compound selected from the group consisting of polyurethanes, polyureas, polyacrylates, aqueous polyacrylates, silicones, polysulphides, silylated polyurethanes, silylated polyureas, silylated polyethers, silylated polysulphides and silyl-terminated acrylates, and (B) at least one ester of an aliphatic or aromatic dicarboxylic or tricarboxylic acid with a C₁₀ alcohol component comprising 2-propylheptanol or comprising a C₁₀ alcohol mixture comprising 2-propylheptanol and at least one of the Cl₁₀ alcohols 2-propyl-4-methylhexanol, 2-propyl-5-methylhexanol, 2-isopropylheptanol, 2-isopropyl-4-methylhexanol, 2-isopropyl-5-methylhexanol and/or 2-propyl-4,4-dimethylpentanol, the aliphatic or aromatic dicarboxylic or tricarboxylic acid being selected from the group consisting of citric acid, phthalic acid, isophthalic acid, terephthalic acid, and trimellitic acid, the adhesive or sealant containing no isononyl benzoate. It has been found, surprisingly, that the adhesives and sealants of the invention, in comparison to the prior art, have lower hardnesses and also low flow points. Furthermore, an improved expansion has been observed on the part of the adhesives and sealants.

The present invention relates accordingly to an adhesive or sealant based on specific binders comprising at least one ester based on 2-propylheptanol, to a process for preparing these adhesives and sealants, and to their use.

In accordance with the invention the adhesive or sealant comprises as component (B) esters of an aliphatic or aromatic dicarboxylic or tricarboxylic acid with a C₁₀ alcohol component comprising 2-propylheptanol or a C₁₀ alcohol mixture comprising 2-propylheptanol and at least one of the C₁₀ alcohols 2-propyl-4-methylhexanol, 2-propyl-5-methylhexanol, 2-isopropylheptanol, 2-isopropyl-4-methylhexanol, 2-isopropyl-5-methylhexanol and/or 2-propyl-4,4-dimethylpentanol, the aliphatic or aromatic dicarboxylic or tricarboxylic acid being selected from the group consisting of citric acid, phthalic acid, isophthalic acid, terephthalic acid, and trimellitic acid.

The expression “alcohol component” is used in order to take account of the circumstance that, in the C₁₀ ester mixtures of the invention, the stated C₁₀ alcohols are present in esterified form.

The C₁₀ alcohol component of the C₁₀ ester mixtures of the invention comprises substantially 2-propylheptanol or mixtures of 2-propylheptanol with one or more of its isomers 2-propyl-4-methylhexanol, 2-propyl-5-methylhexanol, 2-isopropylheptanol, 2-isopropyl-4-methylhexanol, 2-isopropyl-5-methylhexanol and/or 2-propyl-4,4-dimethylpentanol. These compounds are referred to below for short as “propylheptanol isomers”. The presence of other isomers of the 2-propylheptanol component—originating, for example, from the alcohols 2-ethyl-2,4-dimethylhexanol, 2-ethyl-2-methylheptanol and/or 2-ethyl-2,5-dimethylhexanol, which are isomeric with 2-propylheptanol—in the inventive C₁₀ alcohol component is possible. Owing to the low rates of formation of the aldehydic precursors of these isomers in the course of the aldol condensation, these precursors, if at all, are present only in traces in the C₁₀ alcohol component and play virtually no part in the plasticizer properties of the plasticizers comprising the inventive C₁₀ alcohol component.

Pure 2-propylheptanol can be obtained via aldol condensation of n-valeraldehyde and subsequent hydrogenation of the resultant 2-propylheptenal, for example according to U.S. Pat. No. 2,921,089. However, it is preferable to use mixtures of 2-propylheptanol with one or more of the abovementioned propylheptanol isomers as starting alcohol for the C₁₀ alcohol component of the inventive ester mixtures. The isomer composition in the 2-propylheptanol compositions suitable for preparation of the inventive ester mixtures can vary as a function of the nature of the manner of preparation of these compositions and of the nature of the starting material used, and specifically not only with respect to the content of individual isomers in these compositions but also with respect to the presence of certain isomers. A very wide variety of hydrocarbon sources can be utilized as starting material for preparation of 2-propylheptanol, examples being 1-butene, 2-butene, raffinate 1-an alkane/alkene mixture obtained from the C₄ cut from a cracker after removal of acetylene and dienes and also comprising considerable amounts of isobutene alongside 1- and 2-butene—or raffinate II, which is obtained from raffinate I via removal of isobutene and then comprises only very small proportions of isobutene alongside 1- and 2-butene as olefin components. It is, of course, also possible to use mixtures composed of raffinate I and raffinate II as raw material for 2-propylheptanol preparation. These olefins or olefin mixtures can be hydroformylated by methods conventional per se using cobalt catalysts or using rhodium catalysts, whereupon 1-butene gives a mixture composed of n- and isovaleraldehyde—the term isovaleraldehyde indicating for the purposes of this specification the compound 2-methylbutanal—whose n/iso ratio can vary relatively widely as a function of the catalyst used and hydroformylation conditions. By way of example, when a triphenylphosphine-modified homogeneous rhodium catalyst (Rh/TPP) is used, 1-butene forms n- and iso-valeraldehyde in an n/iso ratio which is generally from 10:1 to 20:1, whereas when a rhodium hydroformylation catalyst modified with phosphite ligands is used, for example according to EP-A 155 508 or EP-A 213 639, or modified with phosphoamidite ligands, for example according to WO 02/83695, n-valeraldehyde is formed almost exclusively.

Whereas the Rh/TPP catalyst system gives only very slow reaction of 2-butene in the hydroformylation reaction, the phosphite-ligand- or phosphoramidite-ligand-modified rhodium catalysts mentioned are successful in hydroformylating 2-butene, forming mainly n-valeraldehyde. In contrast, isobutene present in the olefinic raw material is hydroformylated by practically all of the catalyst systems to give 3-methylbutanal, though at varying rates, and, as a function of catalyst, a smaller amount of pivalaldehyde.

The C₅ aldehydes obtained as a function of the catalysts and starting materials used, i.e., n-valeraldehyde optionally in a mixture with isovaleraldehyde, 3-methylbutanal, and/or pivalaldehyde, can, if desired, be to some extent or completely separated by distillation to give the individual components prior to the aldol condensation reaction, and here too there is therefore a possibility of influencing and controlling the isomer composition of the C₁₀ alcohol component of the inventive ester mixtures. Equally, it is possible to introduce the C₅ aldehyde mixture as formed in the hydroformylation reaction, without prior separation of individual isomers, into the aldol condensation reaction. The aldol condensation reaction, which can be carried out by means of a basic catalyst, such as sodium hydroxide or potassium hydroxide, for example by the method described in EP-A 366 089, U.S. Pat. No. 4,426,524, or U.S. Pat. No. 5,434,313, gives 2-propylheptenal as sole condensate if n-valeraldehyde is used, but if a mixture of isomeric C₅ aldehydes is used forms an isomer mixture composed of the products of homoaldol condensation of identical aldehyde molecules and of crossed aldol condensation of different isomers. The aldol condensation reaction can, of course, be controlled via specific reaction of individual isomers in such a way as to form mainly or entirely one single aldol condensation isomer. The relevant aldol condensation products can then, usually after prior, preferably distillative, separation from the reaction mixture and, if desired, distillative purification, be hydrogenated using conventional hydrogenation catalysts to give the corresponding alcohols or alcohol mixtures, which then serve as starting alcohols for the C₁₀ alcohol component in preparation of the inventive ester mixtures.

If desired, other C₁₀ alcohols can also be admixed with the resultant 2-propylheptanol or with its mixture with the propylheptanol isomers, prior to esterification with an aromatic or aliphatic dicarboxylic or tricarboxylic acid, examples being n-decanol, methylnonanols, dimethyloctanols, ethyloctanols, trimethylheptanols, methylethylheptanols, butylhexanols, methylpropylhexanols, methylisopropylhexanols, dimethylethylhexanols, tetramethylhexanols, methyl butylpentanols, methylisobutylpentanols, dimethylpropylpentanols, dimethylisopropylpentanols, trimethylethylpentanols, and pentamethylpentanols, but 2-propylheptanol is preferably used alone or in a mixture with one or more of the propylheptanol isomers for the C₁₀ alcohol component of the inventive ester mixtures.

The content of 2-propylheptanol in the C₁₀ alcohols used for preparation of the inventive ester mixtures and optionally also comprising propylheptanol isomers can be up to 100% by weight and is generally at least 50% by weight, preferably from 60 to 98% by weight, and more preferably from 80 to 95% by weight, in particular from 85 to 95% by weight.

By way of example, suitable mixtures of 2-propylheptanol with the propylheptanol isomers comprise those composed of from 60 to 98% by weight of 2-propylheptanol, from 1 to 15% by weight of 2-propyl-4-methylhexanol, and from 0.01 to 20% by weight of 2-propyl-5-methylhexanol, and from 0.01 to 24% by weight of 2-isopropylheptanol, where the sum of the fractions of the individual constituents does not exceed 100% by weight. The fractions of the individual constituents preferably give a total of 100% by weight.

By way of example, other suitable mixtures composed of 2-propylheptanol with the propylheptanol isomers comprise those composed of from 75 to 95% by weight of 2-propylheptanol, from 2 to 15% by weight of 2-propyl-4-methylhexanol, from 1 to 20% by weight of 2-propyl-5-methylhexanol, from 0.1 to 4% by weight of 2-isopropyl-heptanol, from 0.1 to 2% by weight of 2-isopropyl-4-methylhexanol, and from 0.1 to 2% by weight of 2-isopropyl-5-methylhexanol, where the sum of the fractions of the individual constituents does not exceed 100% by weight. The fractions of the individual constituents preferably give a total of 100% by weight.

Preferred mixtures of 2-propylheptanol with the propylheptanol isomers comprise those with from 85 to 95% by weight of 2-propylheptanol, from 6 to 12% by weight of 2-propyl-4-methylhexanol and from 0.1 to 2% by weight of 2-propyl-5-methylhexanol and from 0.01 to 1% by weight of 2-isopropylheptanol, where the sum of the fractions of the individual constituents does not exceed 100% by weight. The fractions of the individual constituents preferably give a total of 100% by weight.

By way of example, preferred mixtures composed of 2-propylheptanol with the propylheptanol isomers moreover comprise those composed of from 80 to 92% by weight of 2-propylheptanol, from 6 to 12% by weight of 2-propyl-4-methylhexanol, from 7 to 13% by weight of 2-propyl-5-methylhexanol, from 0.1 to 2% by weight of 2-isopropylheptanol, from 0.1 to 1% by weight of 2-isopropyl-4-methylhexanol, and from 0.1 to 1% by weight of 2-isopropyl-5-methylhexanol, where the sum of the fractions of the individual constituents does not exceed 100% by weight. The fractions of the individual constituents preferably give a total of 100% by weight.

The composition of the C₁₀ alcohol component in the inventive ester mixtures practically corresponds to the composition of the propylheptanol isomer mixtures used for its preparation during the esterification process.

The mixtures composed of 2-propylheptanol with the propylheptanol isomers can also comprise traces of n-pentanol, 2-methylbutanol, and/or 3-methylbutanol, as contaminants derived from the preparation process. The amounts of these alcohols are generally in each case at most 0.5%.

The aromatic or aliphatic dicarboxylic or tricarboxylic acid component of the inventive ester mixtures can be citric acid, phthalic acid, isophthalic acid, terephthalic acid or trimellitic acid. Each of the inventive ester mixtures generally comprises, as carboxylic acid component, only one of the dicarboxylic or tricarboxylic acids mentioned. The esters of phthalic acid are particularly preferred. All of these dicarboxylic and tricarboxylic acids, and also the anhydrides of phthalic acid and of trimellitic acid, are produced industrially and are commercially available.

To prepare the inventive C₁₀ ester mixtures, the C₁₀ alcohols can be esterified in a manner conventional per se, for example with proton-acid catalysis, preferably with sulfuric-acid catalysis, or more preferably with amphoteric catalysis by a tetraalcoholate of titanium or of zirconium or of tin in a stoichiometric excess with the relevant dicarboxylic or tricarboxylic acid or anhydride thereof at temperatures of from 80 to 250° C., preferably from 100 to 240° C., in particular at temperatures of from 150 to 230° C., at atmospheric pressure or preferably subatmospheric pressure, and generally with distillative removal of the water of reaction in order to complete conversion in the esterification reaction. After neutralization or hydrolysis and removal of the esterification catalyst, for example in phase separators or via filtration or centrifuging, the resultant ester mixtures can by way of example be separated via distillation from contaminants, such as water or unreacted alcohol. A detailed description of the conduct of this type of esterification process is given for the preparation of phthalic esters by Towae et al in Ullmann's Encyclopedia of Industrial Chemistry, 5th Ed., Vol. A20, pp. 193-196, VCH Publishers, Weinheim 1992, but in principle this is also similarly applicable to the preparation of other dicarboxylic or tricarboxylic esters. Detailed descriptions of the conduct of esterification processes are also found by way of example in WO 02/038531, U.S. Pat. No. B-1 6,310,235, U.S. Pat. No. 5,324,853, DE-A 2 612 355 (Derwent Abstract No. DW 77-72638 Y), or DE-A 1 945 359 (Derwent Abstract No. DW 73-27151 U).

The density at 20° C. of the inventive ester mixtures is generally, as a function of composition, from 0.90 g/cm³ to 1.00 g/cm³, preferably from 0.95 g/cm³ to 0.98 g/cm³, and more preferably from 0.96 g/cm³ to 0.97 g/cm³, measured to DIN 51757 or ASTM D-4052, and their dynamic viscosity at 20° C. is generally, as a function of composition, from 60 mPa*s to 200 mPa*s, preferably from 100 mPa*s to 150 mPa*s, and more preferably from 110 mPa*s to 140 mPa*s, measured to DIN 51562 or ASTM D445.

Component (B) is preferably a phthalic ester of isomeric C₁₀ alcohols.

In the present specification the term “adhesives and sealants” refers to any composition which can be used to produce a connection between two or more articles or bodies, or which is suitable for filling openings, seams or spaces in, on or between one or more articles or bodies (for example grooves, holes, cracks, joints, spaces between adjacent or overlapping articles, pores and seams). Thus sealants are used, for example, for filling spaces caused by adjacent or overlapping structures, such as, for instance, window joints and sanitary joints or else joints in automotive, aircraft or watercraft construction, and also construction joints, civil engineering joints and flooring joints. In specific embodiments the sealants can also be used to make surfaces smooth or, in the form of a sealing compound, to prevent the ingress or egress of moisture, chemicals or gases through the aforementioned openings, joints or cavities, the aforementioned properties not constituting necessary features of the stated adhesives and sealants. Adhesives and sealants cure during or after application, by chemical or physical processes in one or more components of the composition.

In specific embodiments of the present invention the adhesives and sealants are self-curing. This means that, following application, the compositions cure, without the need for external factors, such as heating or irradiation, for the curing process. In other embodiments they may be emulsions of one or more polymers in water or other solvents (polyacrylates for example) which cure physically in the course of drying.

Furthermore, however, it is also possible for the prepolymers used to undergo polymerization as a result of the ambient moisture, as is the case, for example, for the isocyanate-terminated polyurethanes or isocyanate-terminated polyurea prepolymers. The adhesives and sealants of the invention may also be two-component or multi-component systems which are brought into contact with one another and/or mixed with one another shortly before, or during, application, with the reaction thus triggered leading to the curing of the system (examples being two-component polyurethane or polyurea systems).

The polymers used as component A) are generally products obtained by the polymerization of at least one type of monomer. Where the polymers contain two or more types of monomer, these monomers may be arranged in the polymer in any form - that is, they may be present either randomly distributed or in blocks. It is essential to the invention that component (A) used is at least one polymer from the group consisting of polyurethanes, polyureas, polyacrylates, aqueous polyacrylates, silicones, polysulphides, silylated polyurethanes, silylated polyureas, silylated polyethers, silylated polysulphides and silyl-terminated acrylates.

The polyurethanes and polyureas are synthesized from at least one polyol and/or polyamine component and also from a polyisocyanate component, and may optionally comprise chain extenders.

The mode of preparation of the polyurethane or polyurea prepolymers is not critical to the present invention. It may therefore be a one-stage operation, in which the polyols and/or polyamines, polyisocyanates and chain extenders are reacted with one another simultaneously, which may take place, for example, in a batch reaction, or else it may be a two-stage operation, in which, for example, the first product formed is a prepolymer, which is subsequently reacted with chain extenders.

The polyurethanes or polyureas may also comprise further structural units, which more particularly may be allophanates, biuret, uretdione or cyanurates. The aforementioned groups, however, are only examples, and the polyurethanes and polyureas of the invention may also comprise further structural units. The degree of branching as well is not critical to the present invention, and so both linear and highly branched polymers can be used.

In one preferred embodiment of the invention the molar ratio of the isocyanate component present in the polymer to the sum of the polyol and/or polyamine component is 0.01 to 50, preferably 0.5 to 3.0.

The isocyanate component is preferably an aliphatic, cycloaliphatic, araliphatic and/or aromatic compound, preferably a diisocyanate or triisocyanate, and may also comprise mixtures of these compounds. It is regarded here as being preferred for it to be hexa-methylene 1,6-diisocyanate (HDI), HDI uretdione, HDI isocyanurate, HDI biuret, HDI allophanate, 1-isocyanato-3,3,5-trimethyl-5-isocyanatomethylcyclohexane (IPDI), 2,4- and/or 2,6-tolylene diisocyanate (TDI) and/or 4,4′-, 2,4′- and/or 2,2′-diphenylmethane diisocyanate (MDI), polymeric MDI, carbodiimide-modified 4,4′-MDI, m-xylene diisocyanate (MXDI), m- or p-tetramethylxylene diisocyanate (m-TMXDI, p-TMXDI), 4,4′-dicyclohexylmethane diisocyanate (H12MDI), naphthalene-1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI) and 1,12-dodecane diisocyanate (C₁₂DI). It may also be 4-dichlorophenyl diisocyanate, dicyclohexylmethane 4,4′-diisocyanate, m-phenylene diisocyanate, p-phenylene diisocyanate, 4-chloro-1,3-phenylene diisocyanate, 1,6-hexamethylene diisocyanate, 1,10-decamethylene diisocyanate, lysine alkyl ester diisocyanate, 3,3′-dimethyl-4,4′-diphenylmethane diisocyanate, xylylene diisocyanate, tetramethylxylylene diisocyanate, 1,5-tetrahydronaphthalene diisocyanate, triisocyanatotoluene, methylene-bis(cyclohexyl) 2,4′-diisocyanate and 4-methylcyclohexane 1,3-diisocyanate. Suitable more particularly are polyisocyanates having two or three isocyanate groups per molecule. Alternatively this component may comprise mixtures of polyisocyanates, with the average NCO functionality of the isocyanate component in the mixture being able in particular to be 2.1 to 2.3, 2.2 to 2.4, 2.6 to 2.8 or 2.8 to 3.0. Derivatized polyisocyanates may likewise be used, examples being sulphonated isocyanates, blocked isocyanates, isocyanurates and biuret isocyanates.

The polyol and/or polyamine component preferably comprises polyetherester polyol, fatty acid ester polyols, polyether polyols, polyester polyols, polybutadiene polyols and polycarbonate polyols, and may also comprise mixtures of these compounds. The polyols and/or polyamines contain preferably between two and 10, more preferably between two and three hydroxyl groups and/or amino groups, and possess a weight-average molecular weight of between 32 and 30 000, more preferably between 90 and 18 000 g/mol. Suitable polyols are preferably the polyhydroxy compounds that at room temperature are liquids, glasslike solids/amorphous compounds or crystalline compounds. Typical examples might include difunctional polypropylene glycols. It is also possible for preferably hydroxyl-containing random copolymers and/or block copolymers of ethylene oxide and propylene oxide to be used. Suitable polyether polyols are the polyethers known per se in polyurethane chemistry, such as the polyols prepared, using starter molecules, by means of KOH catalysis or DMC catalysis, from styrene oxide, ethylene oxide, propylene oxide, butylene oxide, tetrahydrofuran or epichlorohydrin.

Specific suitability is also possessed more particularly by poly(oxytetramethylene) glycol (polyTHF), 1,2-polybutylene glycol, or mixtures thereof. Particular suitability is possessed by polypropylene oxide, polyethylene oxide and butylene oxide and mixtures thereof. Another type of copolymer which can be used as a polyol component and which terminally contains hydroxyl groups is in accordance with the following general formula (and can be prepared, for example, by means of “controlled” high-speed anionic polymerization according to Macromolecules 2004, 37, 4038-4043):

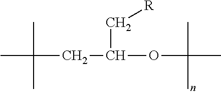

in which R is alike or different and is represented preferably by OMe, OiPr, CI or Br.

Additionally suitable as a polyol component are, more particularly, the polyester diols and polyester polyols which at 25° C. are liquid, glasslike-amorphous or crystalline compounds and which are preparable by condensation of dicarboxylic or tricarboxylic acids, such as adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid and/or dimer fatty acid, with low molecular mass diols, triols or polyols, such as ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol, pentaerythritol and/or trimethylolpropane.

A further suitable group of polyols are the polyesters based, for example, on caprolactone, which are also referred to as “polycaprolactones”. Other polyols which can be used are polycarbonate polyols, dimer fatty alcohols and dimerdiols, and also polyols based on vegetable oils and their derivatives, such as castor oil and its derivatives or epoxidized soybean oil. Also suitable are polycarbonates containing hydroxyl groups, which are obtainable by reacting derivatives of carbonic acid, e.g.

diphenyl carbonate, dimethyl carbonate or phosgene, with diols. Particular suitability is possessed for example by ethylene glycol, 1,2- and 1,3-propanediol, 1,3- and 1,4-butanediol, 1,6-hexanediol, 1,8-octanediol, neopentyl glycol, 1,4-bishydroxymethyl-cyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A, glycerol, trimethylolpropane, 1,2,6-hexanetriol, 1,2,4-butane-triol, trimethylolpropane, pentaerythritol, quinitol, mannitol, sorbitol, methylglycoside and 1,3,4,6-dianhydrohexitols. The hydroxy-functional polybutadienes as well, which are purchasable under trade names including that of “Poly-bd®”, can be used as a polyol component, as can their hydrogenated analogues. Additionally suitable are hydroxy-functional polysulphides, which are sold under the trade name “Thiokol® NPS-282”, and also hydroxy-functional polysiloxanes.

Particular suitability as a polyamine component which can be used in accordance with the invention is possessed by hydrazine, hydrazine hydrate and substituted hydrazines, such as N-methylhydrazine, N,N′-dimethylhydrazine, acid hydrazides of adipic acid, methyladipic acid, sebacic acid, hydracrylic acid, terephthalic acid, isophthalic acid, semicarbazidoalkylene hydrazides, such as 13-semicarbazidopropionyl hydrazide, semicarbazidoalkylene-carbazine esters, such as, for example, 2-semicarbazidoethyl-carbazine ester and/or aminosemicarbazide compounds, such as 13-aminoethyl semi-carbazidocarbonate. Also suitable for preparing the polyurethanes and polyureas are polyamines based on polyesters, polyolefins, polyacetals, polythioethers, polyether-carbonates, polyethylene terephthalates, polyesteramides, polycaprolactams, poly-carbonates, polycaprolactones and polyacrylates which contain at least two amine groups. Polyamines, such as those sold under the trade name of Jeffamine® (which are polyether polyamines), are also suitable.

As polyol component and/or polyamine component, suitability is also possessed by the species which are known as chain extenders and which, in the preparation of polyurethanes and polyureas, react with excess isocyanate groups; they normally have a molecular weight (Mn) of below 400 and are frequently present in the form of polyols, aminopolyols or aliphatic, cycloaliphatic or araliphatic polyamines.

Examples of suitable chain extenders are as follows:
alkanediols, such as ethanediol, 1,2- and 1,3-propanediol, 1,4- and 2,3-butane-diol, 1,5-pentanediol, 1,3-dimethylpropanediol, 1,6-hexanediol, neopentyl glycol, cyclohexanedimethanol, 2-methyl-1,3-propanediol, hexylene glycol, 2,5-dimethyl-2,5-hexanediol, ethylene glycol, 1,2- or 1,3-propanediol, 1,2-, 1,3- or 1,4-butanediol, 1,2-, 1,3-, 1,4- or 1,5-pentanediol, 1,2-, 1,3-, 1,4-, 1,5- or 1,6-hexanediol, neopentyl hydroxypivalate, neopentyl glycol, dipropylene glycol, diethylene glycol, 1,2-, 1,3- or 1,4-cyclohexanediol, 1,2-, 1,3- or 1,4-cyclohexanedimethanol, trimethylpentanediol, ethylbutylpropane-diol, diethyloctanediols, 2-butyl-2-ethyl-1,3-propanediol, 2-butyl-2-methyl-1,3-propanediol, 2-phenyl-2-methyl-1,3-propanediol, 2-propyl-2-ethyl-1,3-propanediol, 2-di-tert-butyl-1,3-propanediol, 2-butyl-2-propyl-1,3-propanediol, 1-dihydroxymethylbicyclo[2.2.1]heptane, 2,2-diethyl-1,3-propanediol, 2,2-dipropyl-1,3-propanediol, 2-cyclohexyl-2-methyl-1,3-propanediol, 2,5-dimethyl-2,5-hexanediol, 2,5-diethyl-2,5-hexanediol, 2-ethyl-5-methyl-2,5-hexanediol, 2,4-dimethyl-2,4-pentanediol, 2,3-dimethyl-2,3-butanediol, 1,4-bis(2′-hydroxypropyl)benzene and 1,3-bis(2′-hydroxy-propyl)benzene, and
δ-hydroxybutyl-ε-hydroxy-caproic esters, ω-hydroxyhexyl-γ-hydroxy-butyric esters, adipic acid-(β-hydroxyethyl) ester or terephthalic acid bisphydroxy-ethyl)ester, and
aliphatic diamines, aromatic diamines and alicyclic diamines, more particularly methylenediamine, ethylenediamine, 1,2- and 1,3-diaminopropane, 1,4-diamino-butane, cadaverine (1,5-diaminopentane), 1,6-hexamethylenediamine, isophorone-diamine, piperazine, 1,4-cyclohexyldimethylamine, 4,4′-diaminodicyclohexyl-methane, aminoethylethanolamine, 2,2,4-trimethylhexamethylenediamine, 2,4,4-tri-methylhexamethylenediamine, octamethylenediamine, m- or p-phenylenediamine, 1,3- or 1,4-xylylenediamine, hydrogenated xylylenediamine, bis(4-aminocyclo-hexyl)methane, 4,4′-methylenebis(ortho-chloroaniline), di(methylthio)toluene-diamine, diethyltoluenediamine, N,N′-di butylaminodiphenylmethane, bis(4-amino-3-methylcyclohexyl)methane, isomer mixtures of 2,2,4- and 2,4,4-trimethyl-hexa-methylenediamine, 2-methylpentamethylenediamine, diethylenetriamine, and 4,4-diaminodicyclohexylmethane, and also
ethanolamine, hydrazineethanol, 2-[(2-ami noethyl)amino]ethanol.

Lastly it should be mentioned that the polyol component and/or polyamine component may contain double bonds, which may result, for example, from long-chain aliphatic carboxylic acids or fatty alcohols. Functionalization with olefinic double bonds is also possible, for example, through the incorporation of vinylic and/or allylic groups, which if desired are alkyl-, aryl- and/or aralkyl-substituted, and also originate unsaturated acids such as maleic anhydride, acrylic acid or methacrylic acid and their respective esters.

For the purposes of the invention it is preferred for the polyol component and/or polyamine component to be polypropylene diol, polypropylene triol, polypropylene polyol, polyethylene diol, polyethylene triol, polyethylene polyol, polypropylenediamine, polypropylenetriamine, polypropylenepolyamine, polyTHF-diamine, polybutadiene diol, polyester diol, polyester triol, polyester polyol, polyesterether diol, polyesterether triol, polyesterether polyol, more preferably polypropylene diol, polypropylene triol, polyTHF diol, polyhexanediol carbamate diol, polycaprolactamdiol and polycaprolactamtriol. It is also possible for these components to be mixtures of the stated compounds.

In one particularly preferred embodiment the polyurethanes or polyureas contain polyols having a molecular weight of between 1000 and 10 000, more particularly 2000 to 6000 and very preferably 3000 to 5000 g/mol. These polyols are, with particular preference, polyTHF diol, polypropylene glycol, and also random copolymers and/or block copolymers of ethylene oxide and propylene oxide. More particularly they may be polyether polyols which in one preferred embodiment have been prepared by DMC catalysis and in one particularly preferred embodiment have been prepared by KOH catalysis. In one preferred embodiment use is made as chain extenders of diols having a molecular weight of 60 to 500, more particularly 60 to 180, the dioligomers of glycols being particularly preferred. With regard to the inventive properties of the adhesives and sealants it is particularly advantageous, furthermore, if the polyurethanes or poly-ureas contain 2,4- and/or 2,6-tolylene diisocyanate (TDI) and/or 4,4′-, 2,4′- and/or 2,2′-diphenylmethane diisocyanate (MDI) and/or 1-isocyanato-3,3,5-trimethyl-5-isocyanato-methylcyclohexane (IPDI), more particularly isomer mixtures of TDI, where a 2,4-isomer fraction of more than 40% is particularly preferred. The combination of the specific polyols and isocyanates specified in this paragraph produces adhesives or sealants of the invention which have a particularly low glass transition temperature and a low tendency towards marginal-zone soiling, without detriment to the further performance properties.

The polyurethanes or polyureas of the present invention may also comprise crosslinker components, chain stopper components and other reactive components. Some crosslinkers have already been listed among the chain extenders having at least three NCO-reactive hydrogens. The compounds in question may more particularly be glycerol, tetra(2-hydroxypropyl)ethylenediamines, pentaerythritol, trimethylolpropene, sorbitol, sucrose, triethanolamine and polymers having at least three reactive hydrogens (e.g. polyetheramines having at least three amine groups, polymeric triols, etc.). Suitable chain stoppers are, in particular, compounds having reactive hydrogens, such as monools, monoamines, monothiols and monocarboxylic acids. One specific embodiment uses monools, where C₁ to C₁₂ alcohols (especially methanol to dodecyl alcohol), higher alcohols, polymers such as, for instance, polyethers and polyesters having an OH group and structural units such as glycerol or sucrose, in which all bar one OH group have been reacted, with no further reactive hydrogen having been introduced in the course of the reaction.

In one particularly UV-stable variant, it is preferred as polyol component to use polyesters having at least two OH groups, polycarbonates having at least two OH groups, polycarbonate esters having at least two OH groups, polyTHF, polypropylene glycol, random copolymers and/or block copolymers of ethylene oxide and propylene oxide.

Polyurethanes comprising adhesives and sealants may further comprise stabilizing additives, to protect, for example, from UV radiation, and oxidation; additives of the HALS type are used more particularly. Mention may be made, by way of example, of 4-amino-2,2,6,6-tetramethylpiperidine.

For the polyurethanes and polyureas it is possible as latent curing agents to use oxazolidines, more particularly oxazolidines formed from diethanolamine and isobutylaldehyde or pivalaldehyde and/or aldimines formed from isophoronediamine, e.g. Incozol HP, and aldol ester based aliphatic di- or trialdimines and imines, e.g. Vestamin A139, low molecular mass aliphatic diamines, e.g. hexanediamine, and/or polyether polyamines such as, for example, Jeffamine® and isobutyraldehyde or pivalaldehyde, and/or a polyamine such as hexamethylenediamine, for example, or a Jeffamin® blocked with a hydroxypivalaldehyde ester.

In one preferred embodiment the adhesive or sealant of the invention comprises polyurethanes or polyureas which contain free isocyanate groups. The compounds in question here are more particularly isocyanate-terminated prepolymers. The isocyanate groups are able to react with water (including moisture from the atmosphere), forming amine groups which react with the isocyanate groups of the other polyurethane or polyurea molecules, and form urea linkages, thereby curing the adhesive or sealant.

In another embodiment, polyurea or polyurethane adhesives and sealants are configured as a two-component system. The first component may comprise a polyisocyanate and/or NCO prepolymer and the second component may comprise a polyol, polyamine and/or chain extender. After the two components have been mixed, these two constituents react with one another, thereby curing the adhesive or sealant.

In a further embodiment in accordance with the invention, polyurethane prepolymers and polyurea prepolymers are reacted with at least one suitable functionalized polymerizable compound containing double bond, such as hydroxyethyl methacrylate, hydroxyethyl acrylate, hydroxypropyl methacrylate, hydroxypropyl acrylate, 4-hydroxy-butyl vinyl ether and isoprenol, for example.

The silylated polyurethanes and silylated polyureas are constructed from at least one polyol or polyamine component, from at least one polyisocyanate component and from at least one silylating component.

As preferred polyol or polyamine component, and polyisocyanate component, all of the compounds specified for the above-described preparation of the polyurethanes and polyureas are suitable. As far as the silylating component present is concerned, suitability is possessed by
1. primary and/or secondary aminosilanes; α or γ position

e.g. H₂N—CH₂—Si(OR²)₃

H₂N—(CH₂)₃—Si(OR²)₃

R′NH—(CH₂)₃—Si(OR²)₃

R′NH—CH₂—CHMe-CH₂—Si(OR²)₃
where OR² independently of one another is represented by an alkoxy group, with R² being an alkyl group having one to 5 carbon atoms, e.g. methyl, ethyl, isopropyl, n-propyl, n-butyl, isobutyl, sec-butyl, and/or OR² is a phenoxy group, a naphthyloxy group, a phenoxy group which is substituted in the ortho-, meta- and/or para-position, with a C₁-C₂₀ alkyl, alkylaryl, alkoxy, phenyl, substituted phenyl, thioalkyl, nitro, halogen, nitrile, carboxyalkyl, carboxyamide, —NH₂ and/or NHR group, in which R is a linear, branched or cyclic C₁-C₂₀ alkyl group, e.g. methyl, ethyl, propyl (n, iso), butyl (n, iso, sec) or cyclohexyl or phenyl, with R′ being a linear, branched or cyclic C₁-C₂₀ alkyl group, e.g. methyl, ethyl, propyl (n, iso), butyl (n, iso, sec) or cyclohexyl or phenyl,
2. isocyanatosilanes; a or y position
3. products obtained by Michael addition of primary aminosilanes in α- and γ-position and ring closure to form the hydantoin, e.g. U.S. Pat. No. 5,364,955.

With regard to the silylating component present, reference is made to patent applications WO 2006/088839 A2 and WO 2008/061651 A1, and also to patent EP 1 685 171 B1, the content of which is hereby adopted into the present specification.

The silylating components which are present in the silylated polyurethane or in the silylated polyurea and which are preferred for the purposes of the present invention are more particularly silanes of the general formula:

Y—R¹—Si(Me)ₙ(OR²)₃₋ₙ

where Y is represented by —NCO, —NHR, —NH₂ or —SH,

R is represented by an alkyl group or aryl group having one to 20 carbon atoms, e.g. methyl, ethyl, isopropyl, n-propyl, butyl group (n-, iso-, sec-), cyclohexyl, phenyl and naphthyl,

R1 is represented by a divalent hydrocarbon unit having one to 10 carbon atoms, e.g. ethylene, methylethylene,

Me is represented by methyl,

OR2 independently of one another is represented by an alkoxy group, where R2 is an alkyl group having one to 5 carbon atoms, e.g. methyl, ethyl, isopropyl, n-propyl, n-butyl, isobutyl, sec-butyl, and/or OR2 is a phenoxy group, a naphthyloxy group, a phenoxy group, which is substituted at the ortho-, meta- and/or para-position, with a C₁-C₂₀ alkyl, alkylaryl, alkoxy, phenyl, substituted phenyl, thioalkyl, nitro, halogen, nitrile, carbon/alkyl, carboxyamide, -NH2 and/or NHR group, in which R is a linear, branched or cyclic C₁-C₂₀ alkyl group, e.g. methyl, ethyl, propyl (n-, iso-), butyl (n-, iso-, sec-) or phenyl, and n is represented by 0, 1, 2 or 3.

As silylating component it is also possible, however, for mixtures of at least two of the stated compounds to be present in the polymer.

In one preferred embodiment, silylating components of interest are more particularly alkoxysilanes comprising isocyanate groups or amino groups. Suitable alkoxysilanes comprising amino groups are more particularly compounds which are selected from the group consisting of 3-aminopropyltrimethoxysilane, 3-aminopropyltriethoxysilane, 3-aminopropylmethyldimethoxysilane, 3-aminopropylmethyldiethoxysilane, 3-amino-2-methylpropyltrimethoxysilane, 4-aminobutyltrimethoxysilane, 4-aminobutylmethyldi-methoxysilane, 4-amino-3-methylbutyltrimethoxysilane, 4-amino-3,3-dimethylbutyl-trimethoxysilane, 4-amino-3,3-dimethylbutyldimethoxymethylsilane, aminomethyltri-methoxysilane, aminomethyldimethoxymethylsilane, aminomethylmethoxydimethyl-silane, ami nomethyltriethoxysilane, ami nomethyldiethoxymethylsilane, aminomethyl-ethoxydimethylsilane, N-methyl-3-aminopropyltrimethoxysilane, N-methyl-3-amino-propyldimethoxymethylsilane, N-ethyl-3-aminopropyltrimethoxysilane, N-ethyl-3-aminopropyldimethoxymethylsilane, N-butyl-3-aminopropyltrimethoxysilane, N-butyl-3-aminopropyldimethoxymethylsilane, N-cyclohexyl-3-aminopropyltrimethoxysilane, N-cyclohexylaminomethyltriethoxysilane, cyclohexylaminomethyltrimethoxysilane, N-phenyl-3-aminopropyltrimethoxysilane, N-methyl-3-amino-2-methylpropyltrimethoxy-silane, N-methyl-3-amino-2-methylpropyldimethoxymethylsilane, N-ethyl-3-amino-2-methylpropyltrimethoxysilane, N-ethyl-3-amino-2-methylpropyldimethoxymethylsilane, N-ethyl-3-aminopropyldimethoxymethylsilane, N-ethyl-3-aminopropyltrimethoxysilane, N-phenyl-4-aminobutyltrimethoxysilane, N-phenylaminomethyldimethoxymethylsilane, N-phenylaminomethyltrimethoxysilane, N-cyclohexylaminomethyldimethoxymethyl-silane, N-cyclohexylaminomethyltrimethoxysilane, N-methylaminomethyldimethoxy-methylsilane, N-methylaminomethyltrimethoxysilane, N-ethylaminomethyldimethoxy-methylsilane, N-ethylaminomethyltrimethoxysilane, N-propylaminomethyldimethoxy-methylsilane, N-propylaminomethyltrimethoxysilane, N-butylaminomethyldimethoxy-methylsilane, N-butylaminomethyltrimethoxysilane, N-(2-aminoethyl)-3-aminopropyl-trimethoxysilane, N-(2-aminoethyl)-3-aminopropylmethyldimethoxysilane, 3-[2-(2-aminoethylamino)ethylamino]propyltrimethoxysilane, bis(trimethoxysilylpropyl)amine, bis(dimethoxy(methyl)silylpropyl)amine, bis(trimethoxysilylmethyl)amine, bis(di-methoxy(methyl)silylmethyl)amine, 3-ureidopropyltrimethoxysilane, N-methyl[3-(tri-methoxysilyl)propyl]carbamates, N-trimethoxysilylmethyl-O-methylcarbamate, N-dimethoxy(methyl)silylmethylcarbamate and the analogues thereof having ethoxy or isopropoxy groups or n-propoxy groups or n-butoxy groups or isobutoxy groups or sec-butoxy groups instead of the methoxy groups on the silicon.

Suitable alkoxysilanes comprising isocyanate groups are more particularly compounds which are selected from the group consisting of isocyanatopropyltriethoxysilane, isocyanatopropyltrimethoxysilane, isocyanatopropylmethyldiethoxysilane, isocyanato-propylmethyldimethoxysilane, isocyanatomethyltrimethoxysilane, isocyanatomethyl-triethoxysilane, isocyanatomethylmethyldiethoxysilane, isocyanatomethylmethyldimethoxysilane, isocyanatomethyldimethylmethoxysilane or isocyanatomethyldimethyl-ethoxysilane, and also their analogues having isopropoxy or n-propoxy groups.

With regard to the silylated polyurethanes for preferred use in accordance with the present invention, and to their preparation, reference is made, furthermore, to patent applications U.S. Pat. No. 3,632,557, U.S. Pat. No. 5,364,955, WO 01/16201, EP 931800, EP 1093482 B1, US 2004 260037, US 2007167598, US 2005119421, U.S. Pat. No. 4,857,623, EP 1245601, WO 2004/060953, and DE 2307794, the content of which is hereby adopted into the present specification.

The acrylates which can be used in accordance with the invention are compounds which include at least one monomer from the series of the acrylic esters and methacrylic esters, with preferably at least 70% by weight of the polymer being composed of at least one compound from the series of the acrylic esters, methacrylic esters and styrenes.

The monomers of the acrylate component preferably comprise at least one compound from the series ethyldiglycol acrylate, 4-tert-butylcyclohexyl acrylate, dihydrocyclo-pentadienyl acrylate, lauryl(meth)acrylate, phenoxyethyl(meth)acrylate, isobornyl(meth)acrylate, dimethylaminoethyl(meth)acrylate, cyanoacrylates, citraconate, itaconate and derivatives thereof, (meth)acrylic acid, methyl(meth)acrylate, ethyl(meth)acrylate, n-propyl(meth)acrylate, isopropyl(meth)acrylate, n-butyl(meth)-acrylate, isobutyl(meth)acrylate, tert-butyl(meth)acrylate, n-pentyl(meth)acrylate, n-hexyl(meth)acrylate, cyclohexyl(meth)acrylate, n-heptyl(meth)acrylate, n-octyl(meth)acrylate, 2-propylheptyl (meth)acrylate, 2-ethylhexyl(meth)acrylate, nonyl(meth)acrylate, decyl(meth)acrylate, isodecyl(meth)acrylate, dodecyl(meth)acrylate, phenyl(meth)acrylate, tolyl(meth)acrylate, benzyl(meth)acrylate, 2-methoxyethyl(meth)acrylate, 3-methoxybutyl(meth)acrylate, 2-hydroxyethyl(meth)acrylate, 2-hydroxypropyl(meth)acrylate, stearyl(meth)acrylate, glycidyl(meth)acrylate, 2-aminoethyl(meth)acrylates, γ-(methacryloyloxypropyl)trimethoxysilane, thylene oxide adducts of (meth)acrylic acid, trifluoromethylmethyl(meth)acrylate, 2-trifluoro-methylethyl(meth)acrylate, 2-perfluoroethylethyl(meth)acrylate, 2-perfluoroethyl-2-perfluorobutylethyl(meth)acrylate, 2-perfluoroethyl(meth)acrylate, perfluoromethyl(meth)acrylate, diperfluoromethylmethyl(meth)acrylate, 2-perfluoromethyl-2-perfluoro-ethylmethyl(meth)acrylate, 2-perfluorohexylethyl(meth)acrylate, 2-perfluorodecylethyl(meth)acrylate and 2-perfluorohexadecylethyl(meth)acrylate.

In one particular embodiment the monomers in question are two or more monomers from the series n-butyl(meth)acrylate, 2-hydroxyethyl(meth)acrylate, acrylic acid, methacrylic acid and methyl methacrylate.

Another embodiment uses copolymers of at least two of all of the aforementioned monomers, the proportion being selected in the form such that the resultant copolymers have the desired performance properties for adhesives and sealants. The skilled person is aware of suitable copolymers having the desired performance properties. Preference is given more particularly to copolymers of n-butyl acrylate and methyl methacrylate, which are used in a molar ratio at which the resultant copolymer possesses a glass transition temperature which lies between those of the corresponding homopolymers. All in all, the acrylates of the present invention may be either copolymers or homopolymers.

The acrylic acid polymers may also, furthermore, comprise other ethylenically unsaturated monomers, examples being isoprenol or hydroxybutyl vinyl ether. Examples here include mono- and polyunsaturated hydrocarbon monomers, vinyl esters (e.g. vinyl esters of C₁ to C₆ saturated monocarboxylic acids), vinyl ethers, monoethylenically unsaturated monocarboxylic and polycarboxylic acids and alkyl esters of these monocarboxylic and polycarboxylic acids (e.g. acrylic esters and methacrylic esters such as, for instance, C₁ to C₁₂ alkyl and more particularly C₁ to C₄ alkyl esters), amino monomers and nitriles, vinyls and alkylvinylidenes and amides of unsaturated carboxylic acids. Also suitable are unsaturated hydrocarbon monomers comprising styrene compounds (e.g. styrene, carboxylated styrene and alpha-methyl-styrene), ethylene, propylene, butylene and conjugated dienes (butadiene, isoprene and copolymers of butadiene and isoprene). The vinyl and halovinylidene monomers include vinyl chloride, vinylidene chloride, vinyl fluoride and vinylidene fluoride. Examples of the vinyl esters include aliphatic vinyl esters, such as vinyl formate, vinyl acetate, vinyl propionate, vinyl butyrate, vinyl isobutyrate, vinyl valerate, vinyl caproate and allyl esters of saturated monocarboxylic acids such as allyl acetate, allyl propionate and allyl lactate. The vinyl ethers include methyl vinyl ether, ethyl vinyl ether and n-butyl vinyl ether. Typical vinyl ketones include methyl vinyl ketones, ethyl vinyl ketones and isobutyl vinyl ketones. Examples of the dialkyl esters of monoethylenically unsaturated dicarboxylic acids are dimethyl maleate, diethyl maleate, dibutyl maleate, dioctyl maleate, diisooctyl maleate, dinonyl maleate, diisodecyl maleate, ditridecyl maleate, dimethyl fumarate, diethyl fumarate, dipropyl fumarate, dibutyl fumarate, dioctyl fumarate, diisooctyl fumarate, didecyl fumarate, dimethyl itaconate, diethyl itaconate, dibutyl itaconate and dioctyl itaconate. In particular the monoethylenically unsaturated monocarboxylic acids are acrylic acid, methacrylic acid, ethacrylic acid and crotonic acid. The monoethylenically unsaturated dicarboxylic acids include maleic acid, fumaric acid, itaconic acid and citric acid. As monoethylenically unsaturated tricarboxylic acids it is possible, with a view to the present invention, to make use, for example, of aconitic acid and its halogen-substituted derivatives. It is possible, furthermore, to use the anhydrides and esters of the aforementioned acids (e.g. maleic anhydride and citric anhydride). Examples of nitriles of ethylenically unsaturated monocarboxylic, dicarboxylic and tricarboxylic acids include acrylonitrile, α-chloro-acrylonitrile and methacrylonitrile. The amides of the carboxylic acids may be acrylamides, methacrylamides and other α-substituted acrylamides and N-substituted amides, e.g. N-methylolacrylamide, N-methylolmethylacrylamide, alkylated N-methylol-acrylamides and N-methylolmethacrylamides (e.g. N-methoxymethylacrylamide and N-methoxymethylmethacrylamide). Amino monomers used may be substituted and unsubstituted aminoalkyl acrylates, hydrochloride salts of the amino monomers, and methacrylates such as, for instance, 3-aminoethyl acrylate, p-aminoethyl methacrylate, dimethylaminomethyl acrylate, β-methylaminoethyl acrylate and dimethylaminomethyl methacrylate. In the context of the present invention, with regard to the cationic monomers, mention may be made of α- and β-ethylenically unsaturated compounds which are suitable for polymerization and contain primary, secondary or tertiary amino groups, examples being di methylaminoethyl methacrylate, dimethylaminoneopentyl acrylate, dimethylaminopropyl methacrylate and tert-butylaminoethyl methacrylate, or organic and inorganic salts of these compounds, and/or alkylammonium compounds such as, for instance, trimethylammonioethyl methacrylate chloride, diallyldimethyl-ammonium chloride, β-acetamidodiethylaminoethyl acrylate chloride and meth-acrylamidopropyltrimethylammonium chloride. These cationic monomers may be used alone or in combination with the aforementioned further monomers. Examples of hydroxy-containing monomers also include the β-hydroxyethyl(meth)acrylates, β-hydroxypropyl(meth)acrylates, γ-hydroxypropyl(meth)acrylates and.

The silyl-terminated acrylates which can be used in accordance with the invention are constructed from at least one acrylate component and at least one silyl component. The silyl-terminated acrylates may be obtained, for example, from the reaction of alkenyl-terminated acrylates by hydrosilylation, the alkenyl-terminated acrylates being preparable by atom transfer radical polymerization (ATRP) or being preparable from the reaction of alkyl-terminated acrylates with a monomer comprising silyl groups, the alkenyl-terminated acrylates being preparable via atom transfer radical polymerization (ATRP).

Suitable monomers for the synthesis of the acrylate component are all of the compounds stated for the above-described preparation of the polyacrylates.

Where the silyl component is attached by hydrosilylation to the acrylate component, suitable silyl components include more particularly trimethylchlorosilane, dimethyl-dichlorosilane, methyltrichiorosilane, hexamethyldisilazane, trichlorosilane, methyl-dichlorosilane, dimethylchlorosilane, phenyldichlorosilane and also trimethoxysilane, triethoxysilane, methyldiethoxysilane, methyldimethoxysilane and phenyldimethoxy-silane, and also methyldiacetoxysilane, phenyldiacetoxysilane, bis(dimethylketoxy-mate)methylsilane and bis(cyclohexylketoxymate)methylsilane. Preferred in this case more particularly are the halosilanes and alkoxysilanes.

Where the silyl component is attached to the acrylate component by a monomer comprising silyl groups, suitable silyl components include more particularly 3-(meth)-acryloyloxypropyltrimethoxysilane, 3-(meth)acryloyloxypropylmethyldimethoxysilane, 3-(meth)acryloyloxypropyltriethoxysilane, 3-(meth)acryloyloxypropylmethyldiethoxy-silane, (meth)acryloyloxymethyltrimethoxysilane, (meth)acryloyloxymethylmethyldi-methoxysilane, (meth)acryloyloxmethyltriethoxysilane, (meth)acryloyloxymethyl-methyldiethoxysilane.

The silyl-terminated acrylates of the invention possess a weight-average molecular weight of between 500 and 200 000 g/mol, more preferably between 5000 and 100 000 g/mol.

With regard to the silyl-terminated acrylates for preferred use in accordance with the present invention, reference is made to patent application EP 1498433 and to Chem. Rev. (2001), 101, 2921-2990, Atom Transfer Radical Polymerization, Krzysztof Matyjaszewski and Jianhui Xia, and to Progress in Polymer Science 32 (2007), 93-146, Controlled/living radical polymerization: Features, developments, and perspectives, Wade A. Braunecker, Krzysztof Matyjaszewski, Elsevier, the content of which is hereby adopted into the present specification.

The polysulphides which can be used in accordance with the invention are organic polymers which have sulphide bonds in the polymer. These may be, by way of example, a product of the reaction of an organic dihalide with sodium disulphide. Examples of the organic dihalides include aliphatic dihalides (e.g. bis-chloroethyl-formal) and vinyl halides. Thus, for example, the reaction of bis-chloroethylformal with a sodium disulphide solution leads to a polymer of the following structure:

—[CH₂CH₂OCH₂OCH₂CH₂Sₓ]ₙ—

in which “n” denotes the number of monomers in the polymer and “x” the number of successive sulphide bonds in the monomer (x may vary in the monomers of the same molecule). High molecular mass polymers of this kind may then be reacted to shorter-chain polymers with terminal thiol groups (for example by reductive reaction with NaSH and Na₂SO₂, and subsequent acidification). In this way, liquid, bridged polysulphides are obtained with terminal thiol end groups, which in specific embodiments have a molecular weight in the range from 1000 to 8000. The liquid polymers may then be cured to form elastomeric solids, as for example by the oxidation of the thiol end groups to disulphite bridges, using an oxidizing reagent such as, for instance, lead oxide, manganese dioxide, para-quinone dioxime and zinc peroxide. For the purposes of the present invention, the polysulphide adhesives and sealants encompass all polysulphide polymers which can be converted to a solid by curing. In specific embodiments the polysulphide adhesives and sealants comprise 30 to 90% by weight of at least one liquid polysulphide polymer, 2 to 50% by weight of a filler, 2 to 10% by weight of a cyclohexanepolycarboxylic acid derivative, 1 to 3% by weight of a water scavenger and between 6 and 15% by weight of further ingredients such as, for instance, adhesion promoters, solvents and curing agents. An example of the preparation of polysulphide adhesives and sealants is disclosed in US 3,431,239, with this method being incorporated into the present specification by reference. Polysulphide adhesives and sealants can be used as one- or two-component systems.

The silylated polysulphides which can be used preferably in accordance with the invention are constructed from at least one polysulphide component and at least one silylating component, and are represented preferably by the following simplified formula:

(CH₃)₃—Si—S—(C₂H₄OCH₂OC₂H₄Sₓ)ₙ—C₂H₄OCH₂OC₂H₄S—Si—(CH₃)₃

These preferred silylated polysulphides are prepared by the following process:

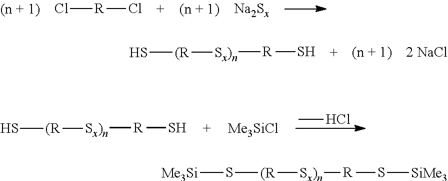

where R is represented by an alkyl group or an ether group.

With regard to the silylated polysulphides whose use is preferred in accordance with the present invention, reference is made to the publication “ALPIS Aliphatische Polysulfide”, Hiithing & Wepf, Basle, 1992, Heinz Lucke, ISBN 3-85739-1243, the content of which is hereby adopted into the present specification.

The silylated polyethers which can be used in accordance with the invention are constructed from at least one polyether component and at least one silylating component. For some time, construction sealants have been on the market that comprise so-called MS-Polymer® from Kaneka and/or Excestar from Asahi Glass Chemical, where “MS” stands for “modified silicone”. These silyl-terminated polyethers are particularly suitable for the present invention. They are polymers which are composed of polyether chains with silane end groups, prepared by the hydrosilylation of terminal double bonds. The silane end groups are composed of a silicon which is attached to the polyether chain and to which two alkoxy groups and one alkyl group, or three alkoxy groups, are attached. As a result of the reaction with moisture, the alkoxy groups undergo hydrolysis to form alcohols, and the resultant Si-OH groups subsequently condense to form an Si-O-Si network.

Suitable polyether components for the silyl-terminated polyethers include, among others, the polyols that are prepared, using starter molecules, from styrene oxide, propylene oxide, butylene oxide, tetrahydrofuran or epichlorohydrin. Especially suitable are polypropylene oxide, polybutylene oxide, polyethylene oxide and tetrahydrofuran or mixtures thereof. In this case, preference is given in particular to molecular weights between 500 and 100 000 g/mol, especially 3000 and 20 000 g/mol.

For the purpose of introducing the double bonds, the polyether is reacted with organic compounds comprising a halogen atom selected from the group consisting of chlorine, bromine and iodine, and with a terminal double bond. Particularly suitable for this purpose are allyl chlorides, allyl bromides, vinyl(chloromethyl)benzene, allyl(chloro-methyl)benzene, allyl(bromomethyl)benzene, allyl chloromethyl ether, allyl(chloro-methoxy)benzene, butenyl chloromethyl ether, 1,6-vinyl(chloromethoxy)benzene, with the use of allyl chloride being particularly preferred.

The resulting polyethers with terminal double bonds are reacted by hydrosilylation to form the silyl-terminated polyethers. Particularly suitable hydrosilylating agents for this reaction include trichlorosilane, methyldichlorosilane, di methylchlorosilane, phenyldi-chlorosilane and also trimethoxysilane, triethoxysilane, methyldiethoxysilane, methyldimethoxysilane and phenyldimethoxysilane, and also methyldiacetoxysilane, phenyldiacetoxysilane, bis(dimethylketoximato)methylsilane and bis(cyclohexylketoximato)methylsilane. Particularly preferred in this context are the halosilanes and alkoxysilanes.

Reference is made, furthermore, to patent applications U.S. Pat. No. 3,971,751, EP 0319896, U.S. Pat. No. 4,618,653, EP 0184829, EP 0265929, EP 1285946, EP 0918062, Adhesives and Sealants—Technology, Applications and Markets, David J. Drunn, ISBN 1-85957-365-7, Rapra Technology Limited, 2003 and Congress proceedings 27 April 2005 Stick 4^{th} European Congress on Adhesive and Sealant Raw Materials, Innovative Raw Materials for Structural Adhesives, ISBN 3-87870-156-X, Vincenz Network, 2005, the content of which is hereby adopted into the present specification.

Besides components (A) and (B), the composition of the invention may comprise additional, further components. These may be, among others, the following auxiliaries and additives:
Adhesion promoters, examples being epoxysilanes, anhydridosilanes, adducts of silanes with primary aminosilanes, ureidosilanes, aminosilanes, diaminosilanes, and also their analogues in the form of monomer or oligomer and urea-silanes; e.g. Dynasylan AMEO, Dynasylan AMMO, Dynasylan DAMO-T, Dynasylan 1146, Dynasylan 1189, Silquest A-Link 15, epoxy resins, alkyl titanates, titanium chelates, aromatic polyisocyanates, phenolic resins; which conform, for example, to the general formula:

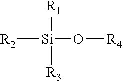

in which

R₁, R₂ and R₃ independently of one another are halogen, amine, hydrogen, alkoxy, acyloxy, alkyl, aryl, aralkyloxy, alkylaryl or aralkyl groups and also alkyl group with olefinic groups, halides, amino, carbonyl, epoxy and glycidyloxy, ester, hydroxyimino, mercapto and sulphido, isocyanato, anhydrido, acryloyloxy, methacryloyloxy and vinyl groups, and also aryl group with olefinic groups, halides, amino, carbonyl, epoxy and glycidyloxy, ester, hydroxyimino, mercapto and sulphido, isocyanato, anhydrido, acryloyloxy, methacryloyloxy and vinyl groups, and also alkylaryl group with olefinic groups, halides, amino, carbonyl, epoxy and glycidyloxy, ester, hydroxyimino, mercapto and sulphido, isocyanato, anhydrido, acryloyloxy, methacryloyloxy and vinyl groups, and also aralkyl group with olefinic groups, halides, amino, carbonyl, epoxy and glycidyloxy, ester, hydroxyimino, mercapto and sulphido, isocyanato, anhydrido, acryloyloxy, methacryloyloxy, and vinyl groups, and R₄ is alkyl and aryl.
Water scavengers, e.g. vinyltriethoxysilane, vinyltrimethoxysilane, α-functional silanes such as N-(silylmethyl)-O-methyl-carbamates, more particularly N-(methyldimethoxysilylmethyl)-O-methyl-carbamate, (methacryloyloxymethyl)silanes, methoxymethylsilanes, N-phenyl-, N-cyclohexyl- and N-alkylsilanes, orthoformic esters, calcium oxide or molecular sieve;
catalysts, examples being metal catalysts in the form of organotin compounds such as dibutyltin dilaurate and dibutyltin diacetylacetonate, organobismuth compounds or bismuth complexes; compounds containing amino groups, examples being 1,4-diazabicyclo[2.2.2]octane and 2,2′-dimorpholinodiethyl ether, 1,8-diazabicyclo[5.4.0]undec-7-enes, 1,5-diazabicyclo[4.3.0]non-5-enes, N,N′-dimethylpiperazines, and also aminosilanes. Further suitable metal catalysts include titanium, zirconium, bismuth, zinc and lithium catalysts, and also metal carboxylates, it also being possible to use combinations of different metal catalysts;
light stabilizers and ageing inhibitors, which act in particular as stabilizers against heat, light and UV radiation, examples being phenolic antioxidants which function as free-radical scavengers, such as 2,6-di-tert-butyl-p-cresol, 2,6-di-tert-butylphenol, 2,4-dimethyl-6-tert-butylphenol, 2,2′-methylenebis(4-methyl-6-tert-butylphenol), 4,4′-butylidenebis(3-methyl-6-tert-butylphenol), 4,4′-thiobis(3-methyl-6-tert-butylphenol), 5-tetrakis[methylene-3-(3,5-di-tert-butyl-4-hydroxyphenyl)propionate]methanes and 1,1,3-tris(2-methyl-4-hydroxy-5-tert-butylphenyl)butanes, and antioxidants based on amines (for example phenyl-β-naphthylamine, α-naphthylamine, N,N′-di-sec-butyl-p-phenylenediamine, phenothiazine and N,N′-diphenyl-p-phenylenediamines);
flame retardants, e.g. Al(OH)₃, huntite, brominated alkyl and aryl compounds, magnesium hydroxide, ammonium polyphosphate;
biocides, such as, for example, algicides, fungicides or fungal growth inhibitor substances, e.g. Ag, Ag⁺, compounds which give off CH₂O—;
fillers, e.g. ground or precipitated calcium carbonates, which optionally are coated with fatty acids or fatty acid mixtures, e.g. stearates, more particularly finely divided, coated calcium carbonate, carbon blacks, especially industrially manufactured carbon blacks, kaolins, aluminium oxides, silicas, more particularly highly disperse silica from pyrolysis processes, PVC powders or hollow beads.

Preferred fillers are carbon black, calcium carbonates, such as precipitated or natural chalks such as Omya 5 GU, Omyalite 95 T, Omyacarb 90 T, Omyacarb 2 T-AV® from Omya, Ultra P-Flex® from Specialty Minerals Inc, Socal® U1S2, Socal® 312, Winnofil® 312 from Solvay, Hakuenka® from Shiraishi, highly disperse silicas from pyrolysis processes, and combinations of these fillers. Likewise suitable are minerals such as siliceous earth, talc, calcium sulphate (gypsum) in the form of anhydrite, hemihydrate or dihydrate, finely ground quartz, silica gel, precipitated or natural barium sulphate, titanium dioxide, zeolites, leucite, potash feldspar, biotite, the group of soro-, cyclo-, ino-, phyllo- and hectosilicates, the group of low-solubility sulphates such as gypsum, anhydrite or heavy spar (BaSO₄), and also calcium minerals such as calcite, metals in powder form (aluminium, zinc or iron, for example), and barium sulphate;
rheology modifiers, such as thickeners, e.g. urea compounds and also mono-amines, e.g. n-butylamine, methoxybutylamine and polyamide waxes, bentonites, silicones, polysiloxanes, hydrogenated castor oil, metal soaps, such as calcium stearate, aluminium stearate, barium stearate, precipitated silica, fumed silica and also poly(oxy-1,2-ethanediyl)-α-hydro-Ω-hydroxy polymer with oxy-1,2-ethanediyl-α-hydro-Ω-hydroxy-nonyl-phenoxyglycidyl ether oligomers and 5-isocyanato-1-(iso-cyanatomethyl)-1,3,3-trimethylcyclohexane or hydroxyethylcellulose or polyacrylic acid polymers and copolymers;
surface-active substances such as, for example, wetting agents, levelling agents, deaerating agents, defoamers and dispersants;
fibres, as for example of carbon, polyethylene or polypropylene, SiO₂, cellulose;
pigments, e.g. titanium dioxide;
solvents such as, for instance, water, solvent naphtha, methyl esters, aromatic hydrocarbons such as polyalkylbenzenes, toluene and xylene, solvents based on esters such as ethyl acetate, butyl acetate, allyl acetate and cellulose acetate, and solvents based on ketones such as methyl ethyl ketone, methyl isobutyl ketone and diisobutyl ketone, and also acetone, and mixtures of at least two of the aforementioned solvents;

and also further substances used in adhesives and sealants.

As further components the adhesives and sealants of the invention may comprise further plasticizers. Such plasticizers are disclosed for example in WO 2008/027463 at page 19, line 5 to page 20, line 9. WO 2008/027463 is hereby referenced and its content hereby incorporated into the present specification.

In one embodiment the adhesive or sealant of the invention comprises 10 to 90% by weight of component (A), 3 to 60% by weight of component (B), 0 to 80% by weight of fillers and 0 to 20% by weight of rheology modifiers. In one preferred embodiment, 1 to 80% by weight of fillers, 0 to 50% by weight of water and/or solvents and 0.5 to 20% by weight of rheology modifiers are present. Considered as being particularly preferred is an amount of 25 to 40% by weight of component (A), 5 to 40% by weight of component (B), 30 to 55% by weight of fillers, 0 to 10% by weight of water and 1 to 10% by weight of rheology modifiers.

In the case of the polyurethanes, silylated polyurethanes, silylated polyureas, silylated polyethers and silylated polysulphides, the adhesives and sealants of the invention are preferably one-component systems. However, it may also be advantageous to configure the system of the invention as two-component systems. In this case one component comprises the polymer component (A), while the second component comprises, for example, a catalyst or micronized water as a booster to accelerate the curing of the system. It is advantageous to ensure that the components employed in a one-component system do not adversely affect the shelflife of the composition, i.e. do not to a significant extent during storage initiate the reaction of the silane groups present in the composition that leads to crosslinking. More particularly this means that such further components preferably no water or at most traces of water. It may therefore be sensible to carry out physical or chemical drying of certain components before incorporating and mixing them into these compositions. If such drying is not possible or not desirable, it may be advantageous in these cases to configure the adhesive or sealant as a two-component system, with the component or components which adversely affect the shelflife being formulated separately from component (A) into the second component.

The compositions of the invention comprising silylated polyurethanes, silylated polyureas, silylated polyethers and silylated polysulphides are stored in the absence of moisture, and are storage-stable, which means that, in the absence of moisture, they can be kept in a suitable pack or facility, such as a drum, a pouch or a cartridge, for example, over a period of several months to a number of years, without suffering any change that is relevant to their practical service in their performance properties or in their properties after curing. The storage stability or shelflife is typically determined via measurement of the viscosity, the extrusion quantity or the extrusion force.

A property of the silane groups is that of undergoing hydrolysis on contact with moisture. This process is accompanied by formation of organosilanols (organosilicon compound comprising one or more silanol groups, SiOH groups) and, by subsequent condensation reactions, organosiloxanes (organosilicon compound comprising one or more siloxane groups, Si-O-Si groups). As the outcome of this reaction, which can be accelerated through the use of catalysts, the composition finally cures. This process is also referred to as crosslinking. The water required for the curing reaction may come from the air (atmospheric humidity), or else the composition may be contacted with a water-comprising component, by being brushed with a smoothing agent, for example, or by being sprayed, or else a water-comprising component may be added to the composition at application, in the form, for example, of a water-containing paste which is mixed in, for example, via a static mixer.

The compositions comprising silane groups cure on contact with moisture. Curing takes place at different rates depending on temperature, nature of contact, amount of moisture, and the presence of any catalysts. Curing by means of atmospheric moisture first forms a skin on the surface of the composition. The so-called skin time formation, accordingly, constitutes a measure of the cure rate. Typically it is desirable to aim for a skinning time of up to 2 hours at 23° C. and 50% relative atmospheric humidity. In the cured state, the compositions comprising silylated polyurethanes, silylated polyureas, silylated polyethers and silylated polysulphides possess a high mechanical strength in conjunction with high expandability, and also have good adhesion properties. This makes them suitable for a multiplicity of applications, more particularly as an elastic adhesive, as an elastic sealant or as an elastic coating. They are especially suitable for applications which require rapid curing and which impose exacting requirements on expandability at the same time as exacting requirements on the adhesion properties and the strengths.

The present invention further provides for the use of the adhesive or sealant as a one- or two-component system for producing material bonds between parts to be joined. In the cured state the composition of the invention possesses a high mechanical strength in conjunction with high expandability, and also good adhesion properties. Consequently it is suitable for a multiplicity of applications, more particularly as an elastic adhesive, as an elastic sealant or as an elastic coating. In particular it is suitable for applications which require rapid curing and impose exacting requirements on expandability at the same time as exacting requirements on the adhesion properties and the strengths.

Suitable applications are, for example, the material bonds between parts to be joined made of concrete, mortar, glass, metal, ceramic, plastic and/or wood. In one particular embodiment the parts to be joined are firstly a surface and secondly a covering in the form of carpet, PVC, laminate, rubber, cork, linoleum, wood, e.g. woodblock flooring, floorboards, boat decks or tiles. The composition of the invention can be used in particular for the jointing of natural stone. Moreover, the adhesives and sealants of the invention can be used for the manufacture or repair of industrial goods or consumer goods, and also for the sealing or bonding of components in construction or civil engineering, and also, in particular, in the sanitary sector. The parts to be joined may especially be parts in automotive, trailer, lorry, caravan, train, aircraft, watercraft and railway construction.

An adhesive for elastic bonds in this sector is applied with preference in the form of a bead in a substantially round or triangular cross-sectional area. Elastic bonds in vehicle construction are, for example, the adhesive attachment of parts such as plastic covers, trim strips, flanges, bumpers, driver's cabs or other components for installation, to the painted body of a means of transport, or the bonding of glazing into the body.

A preferred area of application in construction and civil engineering is that of construction joints, flooring joints, joints in accordance with the German Water Management Law, flashing joints, expansion joints or sealed joints in the sanitary sector. In one preferred embodiment the composition described is used as an elastic adhesive or sealant. In the form of an elastic adhesive, the composition typically has an elongation at break of at least 5%, and in the form of an elastic sealant it typically has an elongation at break of at least 300%, at room temperature.

For use of the composition as a sealant for joints, for example, in construction or civil engineering, or for use as an adhesive for elastic bonds in automotive construction, for example, the composition preferably has a paste-like consistency with properties of structural viscosity. A paste-like sealant or adhesive of this kind is applied by means of a suitable device to the part to be joined. Suitable methods of application are, for example, application from standard commercial cartridges, pouches or pouches inserted in cartridges, which are operated manually or by means of compressed air, or from a drum or hobbock by means of a conveying pump or an eccentric screw pump, optionally by means of an application robot.

The parts to be joined may where necessary be pretreated before the adhesive or sealant is applied. Such pretreatments include, in particular, physical and/or chemical cleaning processes, examples being abrading, sandblasting, brushing or the like, or treatment with cleaners or solvents, or the application of an adhesion promoter, an adhesion promoter solution or a primer.

In the context of its use as an adhesive, the composition of the invention is applied either to one or the other part to be joined, or to both parts to be joined. Thereafter the parts to be bonded are joined, and the adhesive cures. It must in each case be ensured that the joining of the parts takes place within what is referred to as the open time, in order to ensure that the two parts to be joined are reliably bonded to one another.

The present invention further provides a process for preparing an adhesive or sealant, where a) a portion of component (A), preferably between 10 and 50% by weight of component (A), and all of component (B) and, optionally, further components, more particularly from the group consisting of filler, thixotropic agent, antioxidant and UV absorber, are introduced, (b) optionally at least one compound from the group consisting of solvent and adhesion promoter, and (c) the remainder of component (A) and optionally further components, more particularly from the group consisting of fillers, thixotropic agent, antioxidant, UV absorber, solvent and adhesion promoter, are added and mixed.

For the preparation process of the invention it is considered preferred that the components employed are mixed with one another and/or kept moving throughout the entire operation. Alternatively the components employed may also be mixed with one another only at the end of the preparation process. Suitable mixing equipment encompasses all of the apparatus known for this purpose to the skilled person, and more particularly may be a static mixer, planetary mixer, horizontal turbulent mixer (from Drais), planetary dissolver or Dissolver (from PC Laborsysteme), intensive mixer and/or extruder.

The process of the invention for preparing the adhesive or sealant may be carried out discontinuously in, for example, a planetary mixer. It is, however, also possible to operate the process continuously, in which case extruders in particular have been found suitable for this purpose. In that case the binder is fed to the extruder, and liquid and solid adjuvants are metered in.

It has been found, surprisingly, that the adhesives and sealants of the invention, in comparison to the prior art, exhibit a low hardness and a relatively low yield point. Moreover, an increased expansion has been observed on the part of the adhesives and sealants. Through the provision of the adhesives and sealants of the invention, therefore, it has been possible to solve the stated problem in its entirety.

The examples which follow illustrate the advantages of the present invention.

### PREPARATION EXAMPLE 1

Preparation of a C₁₀ Phthalic Ester Mixture

A mixture of alcohols having 10 carbon atoms (2.4 mol; 1.2-fold stoichiometric excess), containing 89.49% by weight of 2-propylheptanol, 10.47% by weight of 2-propyl-4-methylhexanol and 0.04% by weight of 2-propyl-5-methylhexanol, was reacted with phthalic anhydride (1.0 mol) in the presence of isopropyl butyl titanate (0.001 mol) as catalyst in an autoclave, with bubbling in of N₂ and stirring, at a reaction temperature of 230° C. The water of reaction formed was removed continuously with the N₂ stream from the reaction mixture. The reaction time was 180 minutes. Subsequently, excess alcohols were removed by distillation under a pressure of 50 mbar. The crude C₁₀ phthalic ester mixture was neutralized with 0.5% strength aqueous sodium hydroxide solution at 80° C. with stirring. A two-phase mixture was formed, having an upper organic phase and a lower aqueous phase (waste liquor with hydrolyzed catalyst). The aqueous phase was separated off and the organic phase was washed twice with H₂O. For further purification, the neutralized and washed C₁₀ phthalic ester mixture was steamed off with steam at 180° C. under a pressure of 50 mbar. The C₁₀ phthalic ester mixture thus purified was then dried at 150° C/50 mbar by passing a stream of N₂ through it, and then stirred with activated carbon and filtered through a suction filter with Supra-Theorit filter aid at a temperature of 80° C. and with application of reduced pressure. The resultant C₁₀ phthalic ester mixture of the invention possesses a density at 20° C. (DIN 51757 or ASTM D-4052) of 0.96 g/cm³ and a dynamic viscosity at 20° C. (DIN 51562 or ASTM D445) of 120 mPa*s.

### APPLICATION EXAMPLE 1

⅓ of the binder Desmoseal M 280, the respective plasticizer, Omyacarb 5 GU, and ⅔ of the Ti additive were introduced and mixed with one another under reduced pressure at a temperature of 60° C. Then 2/3 of Desmoseal M 280 and Aerosil R 202 were added. In the last step, Dynasylan GLYMO, ⅓ of Ti additive and Lupranat N 106 DMDEE were added and mixed. The sealant was filled into aluminium or plastic cartridges. The respective formulations are reproduced in Table 1, with the numerical figures in columns two to five relating to parts by weight.

TABLE 1

| | Palatinol | Eastman | | Jayflex | % by |
|---|---|---|---|---|---|
| | 10-P | 168 | Mesamoll | DIDP | weight |
| Plasticizer | 160.00 | 160.00 | 160.00 | 160.00 | 20.00 |
| Desmoseal M 280 | 240.00 | 240.00 | 240.00 | 240.00 | 30.00 |
| Omyacarb 5 GU | 337.60 | 337.60 | 337.60 | 337.60 | 42.20 |
| Aerosil R 202 | 48.00 | 48.00 | 48.00 | 48.00 | 6.00 |
| Dynasylan | 8.00 | 8.00 | 8.00 | 8.00 | 1.00 |
| GLYMO | | | | | |
| Ti additive | 6.00 | 6.00 | 6.00 | 6.00 | 0.75 |
| Lupranat N 106 | 0.40 | 0.40 | 0.40 | 0.40 | 0.05 |
| DMDEE | | | | | |
| Total | 800.00 | 800.00 | 800.00 | 800.00 | 100.00 |

Key:
Desmoseal M 280: polyurethane binder from Bayer MaterialScience AG
Jayflex DIDP: diisodecyl phthalate from Exxon Mobil Corporation
Palatinol 10-P: di-2-propylheptyl phthalate from BASF SE
Mesamoll: alkanesulphonic acid phenyl ester from Lanxess Deutschland GmbH
Eastman 168: bis(2-ethylhexyl) terephthalate from Eastman Chemical Company
Omyacarb 5 GU: ground chalk from Omya Inc.
Ti additive: toluenesulphonyl isocyanate from OMG Borchers GmbH
Aerosil R 202: fumed silica from Evonik Degussa GmbH
Dynasylan GLYMO: 3-glycidyloxypropyltrimethoxysilane from Evonik Degussa GmbH
Lupranat N 106 DMDEE: 2,2′-dimorpholinyldiethyl ether from BASF SE

The results are reproduced in Table 2.

TABLE 2

| | Palatinol | Eastman | | Jayflex |
|---|---|---|---|---|
| | 10-P | 168 | Mesamoll | DIDP |
| Expansion % after | 298 | 245 | 238 | 275 |
| 7 days' storage at | | | | |
| 20° C. (DIN 53504) | | | | |
| Shore A hardness | 35 | 46 | 40 | 40 |
| (DIN 53505) | | | | |
| Yield point Pa | 7496 | 9177 | 11 390 | 9900 |

As is evident from the examples, the addition of Palatinol 10 P allows the expansion to be increased relative to the use of conventional phthalates in the adhesive and sealant. At the same time, the hardness is reduced and the processing properties, in the form of a low yield point, are improved.

### APPLICATION EXAMPLE 2

The binder Acronal S 410 was adjusted to a pH of 8. Thereafter the Pigmentverteiler NL pigment dispersant was introduced, Lutensol NO 89 was added, and the components were mixed with one another. Subsequently the respective plasticizer, Kronos 2056 and Omyacarb 5 GU were added and mixed. The sealant was filled into aluminium or plastic cartridges. The respective formulations are reproduced in Table 3.

TABLE 3

| | Palatinol | Eastman | | Jayflex | % by |
|---|---|---|---|---|---|
| | 10-P | 168 | Mesamoll | DIDP | weight |
| Acronal S 410 | 256.00 | 256.00 | 256.00 | 256.00 | 32.00 |
| pH 8 | | | | | |
| Pigmentverteiler | 4.80 | 4.80 | 4.80 | 4.80 | 0.60 |
| NL | | | | | |
| Lutensol A/O 89 | 2.40 | 2.40 | 2.40 | 2.40 | 0.30 |
| Plasticizer | 80.00 | 80.00 | 80.00 | 80.00 | 10.00 |
| Kronos 2056 | 12.00 | 12.00 | 12.00 | 12.00 | 1.50 |
| Omyacarb 5 GU) | 444.80 | 444.80 | 444.80 | 444.80 | 55.60 |
| Total | 800.00 | 800.00 | 800.00 | 800.00 | 100.00 |

The numerical figures in columns two to five relate to parts by weight.
Acronal S 410: acrylate dispersion from BASF SE
Pigmentverteiler NL: sodium polyacrylate pigment dispersant in water, from BASF SE
Lutensol A/O 89: fatty alcohol ethoxylate, in water, from BASF SE
Jayflex DIDP: diisodecyl phthalate from ExxonMobil Corporation
Eastman 168: bis(2-ethylhexyl) terephthalate from Eastman Chemical Company
Mesamoll: alkanesulphonic acid phenyl ester from Lanxess Deutschland GmbH
Omyacarb 5 GU: ground chalk from Omya Inc.
Kronos 2056: titanium dioxide from Kronos International, Inc.

The results are reproduced in Table 4.

TABLE 4

| | Palatinol | Eastman | | Jayflex |
|---|---|---|---|---|
| | 10-P | 168 | Mesamoll | DIDP |
| Expansion % after | 104.11 | 89.90 | 69.09 | 96.67 |
| 7 days' storage at | | | | |
| 20° C. (DIN 53504) | | | | |
| Shore A hardness | 15 | 18 | 20 | 16 |
| (DIN 53505) | | | | |
| Yield point Pa | 6969 | 8752 | 7295 | 8094 |

As is evident from the examples, the addition of Palatinol 10 P allows the expansion to be increased relative to the use of conventional plasticizers in the adhesive and sealant. At the same time, the hardness is reduced and the processing properties, in the form of a low yield point, are improved.

### APPLICATION EXAMPLE 3

General Preparation Procedure

Plasticizer, Socal U1S2, Omyalite 90 T, Crayvallac SLX and Dynasylan VTMO were introduced and mixed with one another under reduced pressure and at a temperature of 60° C. for 30 minutes. Subsequently the polymer ST XP 75 was added. In the last step, Dynasylan AMMO and Metatin 740 were added and mixed. The sealant was filled into aluminium or plastic cartridges. The respective formulations are indicated in Table 5.

TABLE 5

| | Palatinol | Eastman | | Jayflex | % by |
|---|---|---|---|---|---|
| | 10-P | 168 | Mesamoll | DIDP | weight |
| Plasticizer | 120.00 | 120.00 | 120.00 | 120.00 | 15.00 |
| Socal U1S2 | 385.60 | 385.60 | 385.60 | 385.60 | 48.20 |
| Polymer ST | 240.00 | 240.00 | 240.00 | 240.00 | 30.00 |
| XP 75 | | | | | |
| Crayvallec SLX | 8.00 | 8.00 | 8.00 | 8.00 | 1.00 |
| Omyalite 90 T | 32.00 | 32.00 | 32.00 | 32.00 | 4.00 |
| Dynasylan | 5.60 | 5.60 | 5.60 | 5.60 | 0.70 |
| VTMO | | | | | |
| Dynasylan | 8.00 | 8.00 | 8.00 | 8.00 | 1.00 |
| AMMO | | | | | |
| Metatin 740 | 0.80 | 0.80 | 0.80 | 0.80 | 0.10 |
| Total | 800.00 | 800.00 | 800.00 | 800.00 | 100.00 |

The numerical figures in columns two to five relate to parts by weight.
Polymer ST XP 75: Silane-terminated polyurethane binder from Hanse Chemie AG
Eastman 168: bis(2-ethylhexyl) terephthalate from Eastman Chemical Company
Omyalite 90 T: high-purity surface-treated calcium carbonate from Omya Inc.
Crayvallac SLX: micronized amide wax from Cray Valley
Dynasylan VTMO: vinyltrimethoxysilane from Evonik Degussa GmbH
Dynasylan AMMO: 3-aminopropyltrimethoxysilane from Evonik Degussa GmbH
Metatin 740: dibutyltin ketonate from Acima AG
Socal U1S2: precipitated chalk, ultrafine, coated, from Solvay S.A.
Jayflex DIDP: diisodecyl phthalate from ExxonMobil Corporation
Palatinol 10-P: di-2-propylheptyl phthalate from BASF SE
Mesamoll: alkanesulphonic acid phenyl ester from Lanxess Deutschland GmbH

The results are reproduced in Table 6

TABLE 6

| | Palatinol | Eastman | | Jayflex |
|---|---|---|---|---|
| | 10-P | 168 | Mesamoll | DIDP |
| Expansion % after | 618 | 482 | 537 | 524 |
| 7 days' storage at | | | | |
| 20° C. (DIN 53504) | | | | |
| Shore A hardness | 40 | 44 | 43 | 44 |
| (DIN 53505) | | | | |
| Yield point Pa | 11 530 | 18 490 | 23 830 | 15 620 |

As is evident from the examples, the addition of Palatinol 10 P increases the expansion relative to the use of conventional plasticizers in the adhesive and sealant. At the same time, the hardness is reduced and the processing properties, in the form of a low yield point, are improved.

Determination of the Yield Point:

For all of the examples, the yield point was carried out using a PHYSICA MCR 301 MODULAR COMPACT RHEOMETER (Manufacturer: Anton Paar GmbH, Graz, AT). The measuring system selected was a plate/plate system with a diameter of 50 mm. The gap width was 2 mm. Measurement took place at 23° C. under the following provisions: deformation 0.01-100%; circular frequency: 10 Hz. In the course of measurement, loss modulus and storage modulus were recorded, and their point of intersection was ascertained. The resulting value is identified as the yield point.

1.-14. (canceled)

15. An adhesive or sealant comprising
(A) at least one compound selected from the group consisting of polyurethanes, polyureas, polyacrylates, aqueous polyacrylates, silicones, polysulphides, silylated polyurethanes, silylated polyureas, silylated polyethers, silylated polysulphides and silyl-terminated acrylates, and
(B) at least one ester of an aliphatic or aromatic dicarboxylic or tricarboxylic acid with a C₁₀ alcohol component comprising 2-propylheptanol, or a C₁₀ alcohol mixture comprising 2-propylheptanol and at least one of the C₁₀ alcohols 2-propyl-4-methylhexanol, 2-propyl-5-methylhexanol, 2-isopropylheptanol, 2-isopropyl-4-methylhexanol, 2-isopropyl-5-methylhexanol and/or 2-propyl-4,4-dimethylpentanol, the aliphatic or aromatic dicarboxylic or tricarboxylic acid being selected from the group consisting of citric acid, phthalic acid, isophthalic acid, terephthalic acid and trimellitic acid,
wherein the adhesive or sealant contains no isononyl benzoate.

16. The adhesive or sealant according to claim 15, characterized in that it comprises at least the following components:
10 to 90% by weight of component (A)
3 to 60% by weight of component (B)
0 to 80% by weight of fillers
0 to 20% by weight of rheology modifiers.

17. The adhesive or sealant according to claim 15, characterized in that component (B) comprises at least one phthalic ester of a 2-propylheptanol isomer.

18. The adhesive or sealant according to claim 15, characterized in that further components comprised are auxiliaries and additives, dispersants, film-forming assistants, pigments, rheological assistants, water scavengers, adhesion promoters, catalysts, light stabilizers, ageing inhibitors, flame retardants, solvents and/or biocides.

19. The adhesive or sealant according to claim 15, characterized in that it is a one-component system.

20. The adhesive or sealant according to claim 15, characterized in that it is a two-component system.

21. A process for preparing an adhesive or sealant of claim 15, characterized in that
a) a portion of component (A) and optionally at least one compound from the series consisting of filler, thixotropic agent, antioxidant and UV absorber is introduced together with all of component (B),
b) optionally at least one compound from the series consisting of solvent and adhesion promoter, and
c) the remainder of component (A) and optionally of further components, especially from the series consisting of fillers, thixotropic agent, antioxidant and UV absorber, solvent and adhesion promoter, are added, the components being mixed homogeneously.

22. The process for preparing an adhesive or sealant according to claim 21, characterized in that the process is carried out discontinuously.

23. The process for preparing an adhesive or sealant according to claim 21, characterized in that the process is carried out continuously.

24. A method of producing material bonds between parts to be joined comprising utilizing the adhesive or sealant of claim 15.

25. The method of claim 25, wherein the parts to be joined comprises any one or a combination of stone, concrete, mortar, glass, metal, ceramic, plastic and/or wood.

26. The method of claim 25, characterized in that one of the parts to be joined is a surface and the other is a carpet covering, a PVC covering, a laminate, a rubber covering, a cork covering, a linoleum covering, a wood covering or tiles.

27. The method of claim 25, characterized in that the material bond is a construction joint, an expansion joint, a flooring joint, a façade joint, building partition joints, flashing joints, glazing, window glazing, structural glazing, roof glazing, window sealing or a sealed joint in the sanitary sector.

28. The method of claim 25, characterized in that the parts to be joined are parts in electrical, mechanical, automotive, lorry, caravan, train, trailer, aircraft, watercraft and railway construction.
